(19) United States
(12) Patent Application Publication
(10) Pub. No.: US 2024/0133852 A1
(43) Pub. Date: Apr. 25, 2024

(54) SELECTIVE MONITORING OF BASE CHEMICALS

(71) Applicant: ECI TECHNOLOGY, INC., Totowa, NJ (US)

(72) Inventors: Eugene Shalyt, Washington Township, NJ (US); Chuannan Bai, Bridgewater, NJ (US); Aaron Haber, Flushing, NJ (US)

(73) Assignee: ECI TECHNOLOGY, INC., TOYOWA, NJ (US)

(21) Appl. No.: 18/269,154

(22) PCT Filed: Jan. 6, 2022
(86) PCT No.: PCT/US2022/011354

§ 371 Date: Jun. 21, 2023

Related U.S. Application Data
(60) Provisional application No. 63/140,405, filed on Jan. 22, 2021.

(51) Int. Cl. G01N 31/16; G01N 31/22

(52) U.S. Cl. CPC G01N 31/16; G01N 31/221; G01N 31/227

(57) ABSTRACT

Methods for selective measurement and monitoring of multiple base chemicals in processing solutions are provided. Methods include providing a processing solution including a plurality of base chemicals and performing a first analytical method, such as measuring a conductivity of the solution blend, in combination with a second analytical method, such as titration or pH measurements of the solution. From such measurements, a concentration of one or more base chemicals can be selectively determined. In such methods, multiple bases in a same processing solution are advantageously selectively measured and monitored accurately.

### CROSS-REFERENCE TO RELATED APPLICATIONS

This U.S. National Phase application claims priority to PCT/US2022/011354, filed Jan. 6, 2022, which claims priority to U.S. Provisional Patent Application Ser. No. 63/140,405, filed Jan. 22, 2021, both the contents of which are hereby incorporated by reference herein in its entirety.

### FIELD

The present disclosure relates to analysis of processing solutions, for example, semiconductor processing solutions, and more particularly to techniques for measurement and monitoring of multiple base chemicals in such processing solutions.

### BACKGROUND

Process solutions are used in several industries, including semiconductor industries, in order to produce products with desired properties. Such process solutions can include base chemicals, for example, for use in material processing. One group of base chemicals include hydroxides which can be represented as X—OH in which X can be a metal. Another group of base chemicals can be nitrogen based, for example, which can be represented as (R1-N—R2,R2,R3)+. In some instances, certain bases can have both characteristics, for example, ammonium hydroxide (NH₄OH) and tetramethylammonium hydroxide ((CH₃)₄ N(OH)) or TMAH.

Different base materials can provide different processing characteristics in solution. As such, the combination of multiple base chemicals can be employed, for example, to provide products with certain characteristics. Process control can require the accurate and selective measurement and monitoring of multiple bases in the solution blend. Certain methods can provide for the consecutive titration of two bases. However, such methods can require a relatively large difference in pK values (e.g., a strong base and a weak base), and can be limited as two strong bases cannot be differentiated from each other in solution. Other methods include consecutive titration of two bases in the presence of solvents. The solvent can manipulate the strength of the base and in some instances force two different bases to have different properties. For example, one base can become a strong base and another base can become a weak base. However, the use of flammable solvents can create a safety risk and can be an environmental hazard. Further methods include ion chromatography and capillary electrophoresis, but can be expensive, difficult to automate, and have a relatively long analysis time.

It is thus desirable for processes to provide for economic, safe, efficient, rapid, and accurate selective measurement and monitoring of multiple base chemicals in processing solutions, for example, of two base chemicals in a solution blend.

### SUMMARY

Methods of the present disclosure provide for selective measurement and monitoring of multiple base chemicals in process solutions, such as semiconductor processing solutions. Specifically, in certain embodiments, the present disclosure provides for selective measurement and monitoring of multiple base chemicals by combining a first analytical method, such as titration or pH measurements, with a second analytical method, such as conductivity measurements. In such methods, multiple base chemicals in a same processing solution can be selectively measured and monitored accurately. Further, such methods provide an economic, safe, efficient, and rapid means for determining the same.

An exemplary method for determining a concentration of at least one base chemical in a processing solution including a first base chemical and a second base chemical is provided. The method includes performing a first analytical method comprising measuring a conductivity of the processing solution to provide a first measurement; performing a second analytical method of the processing solution to provide a second measurement; and determining a concentration of at least one of the first base chemical and the second base chemical based on the first and second measurements. The first base chemical is different than the second base chemical. The first analytical method is different than the second analytical method.

In certain embodiments, the second analytical method can include titrating the processing solution.

In certain embodiments, the second analytical method can include measuring the pH of the processing solution.

In certain embodiments, the first base chemical and the second base chemical can be strong bases.

In certain embodiments, the processing solution can be a semiconductor processing solution.

In certain embodiments, the first base chemical can be a hydroxide compound. In certain embodiments, the first base chemical can be sodium hydroxide (NaOH), potassium hydroxide (KOH), or lithium hydroxide (LiOH).

In certain embodiments, the second base chemical can be an amine compound. In certain embodiments, the second base chemical can be monoethylamine (MEA), ammonium hydroxide, tetramethylammonium hydroxide (TMAH), tetraethyl ammonium hydroxide (TEAH), tetrapropylammonium hydroxide, trimethylhydroxyethylammonium hydroxide, dimethyldihydroxyethylammonium hydroxide, methyltrihydroxyethylammonium hydroxide, phenyltrimethylammonium hydroxide, phenyltriethylammonium hydroxide, or benzyltrimethylammonium hydroxide.

In certain embodiments, the conductivity of the processing solution can be measured at a fixed temperature.

Methods for determining a concentration of at least one base chemical in a processing solution including a hydroxide compound and an amine compound is provided. An exemplary method includes performing a first analytical method comprising measuring a conductivity of the processing solution to provide a first measurement; performing a second analytical method of the processing solution to provide a second measurement; and determining a concentration of at least one of the hydroxide compound and the amine compound based on the first and second measurements. The first analytical method is different than the second analytical method.

In certain embodiments, the second analytical method can include titrating the processing solution.

In certain embodiments, the second analytical method can include measuring the pH of the processing solution.

In certain embodiments, the hydroxide compound and the amine compound can be strong bases.

In certain embodiments, the processing solution can be a semiconductor processing solution.

In certain embodiments, the hydroxide compound can be sodium hydroxide (NaOH), potassium hydroxide (KOH), or lithium hydroxide (LiOH).

In certain embodiments, the amine compound can be monoethylamine (MEA), ammonium hydroxide, tetramethylammonium hydroxide (TMAH), tetraethyl ammonium hydroxide (TEAH), tetrapropylammonium hydroxide, trimethylhydroxyethylammonium hydroxide, dimethyldihydroxyethylammonium hydroxide, methyltrihydroxyethylammonium hydroxide, phenyltrimethylammonium hydroxide, phenyltriethylammonium hydroxide, or benzyltrimethylammonium hydroxide.

In certain embodiments, the conductivity of the processing solution can be measured at a fixed temperature.

### BRIEF DESCRIPTION OF THE DRAWINGS

FIG. 1A illustrates the results of the measured concentration (N) of sodium hydroxide (NaOH) by conductivity and titration measurements versus the expected concentration (N) of NaOH in a solution blend in accordance with Example 1;

FIG. 1B illustrates the results of the measured concentration (N) of monoethylamine (MEA) by conductivity and titration measurements versus the expected concentration (N) of MEA in a solution blend in accordance with Example 1;

FIG. 1C illustrates the results of the measured concentration (N) of sodium hydroxide (NaOH) by conductivity and pH measurements versus the expected concentration (N) of NaOH in a solution blend in accordance with Example 1;

FIG. 2A illustrates the results of the measured concentration (wt %) of Base 1 (B) by conductivity and titration measurements versus the expected concentration (wt %) of Base 1 (B) in a solution blend in accordance with Example 2;

FIG. 2B illustrates the results of the measured concentration (wt %) of Base 2 (TMAH) by conductivity and titration measurements versus the expected concentration (wt %) of Base 2 (TMAH) in a solution blend in accordance with Example 2;

FIG. 2C illustrates the results of the measured concentration (wt %) of Base 1 (B) by conductivity and pH measurements versus the expected concentration (wt %) of Base 1 (B) in a solution blend in accordance with Example 2; and

FIG. 2D illustrates the results of the measured concentration (wt %) of Base 2 (TMAH) by conductivity and pH measurements versus the expected concentration (wt %) of Base 2 (TMAH) in a solution blend in accordance with Example 2.

### DETAILED DESCRIPTION

The present disclosure provides techniques for selective measurement and monitoring of multiple base chemicals in processing solutions such as semiconductor processing solutions. In certain embodiments, the present disclosure provides for combining a first analytical method, such as titration or pH measurements, with a second analytical method, such as conductivity measurements, to accurately determine the concentration of one or more base chemicals in a solution blend. Accordingly, multiple base chemicals in a same processing solution can be advantageously selectively measured and monitored. In certain embodiments, the processing solution can include multiple strong bases.

Technical terms used in the present disclosure are generally known to those skilled in the art. The phrase “predetermined concentration” as used herein refers to a known, target, or optimum concentration of a component in a solution.

A “strong base” as used herein refers to a base that can completely ionize in solution. In certain aspects, a “strong base” as used herein refers to a basic chemical compound that can remove a proton (H⁺) from a molecule of even a very weak acid in an acid-base reaction.

A “weak base” as used herein refers to a base that does not completely ionize in solution. In certain aspects, a “weak base” as used herein refers to a base chemical compound with incomplete protonation.

As used herein, the term “selective” or “selectively” refers to, for example, the particular monitoring, measurement or determination of a characteristic of a specific or particular component. For example, the selective measurement of a base chemical refers to the measurement of one particular or predetermined target base chemical from a plurality of base chemicals present in solution.

As used herein, the term “accurate” or “accurately” refers to, for example, a measurement or determination that is relatively close to or near an existing or true value, standard, or known measurement or value.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

The methods of the present disclosure can be applied to various types of solutions including processing solutions. In certain embodiments, the processing solution can be a semiconductor processing solution.

In certain embodiments, the processing solution can include one or more base chemicals. A person skilled in the art will appreciate that a wide variety of base chemicals are suitable for use with the present disclosure. In certain embodiments, the one or more base chemicals can include hydroxide compounds. In certain embodiments, the hydroxide compounds can include sodium hydroxide (NaOH), potassium hydroxide (KOH), or lithium hydroxide (LiOH). A person skilled in the art would appreciate a wide variety of hydroxide compounds are suitable for use with the present disclosure. In certain embodiments, the one or more base chemicals can include amine compounds. In certain embodiments, the amine compounds can include monoethylamine (MEA), ammonium hydroxide, tetramethylammonium hydroxide (TMAH), tetraethyl ammonium hydroxide (TEAH), tetrapropylammonium hydroxide, trimethylhydroxyethylammonium hydroxide, dimethyldihydroxyethylammonium hydroxide, methyltrihydroxyethylammonium hydroxide, phenyltrimethylammonium hydroxide, phenyltriethylammonium hydroxide, benzyltrimethylammonium hydroxide, etc. A person skilled in the art would appreciate a wide variety of amine compounds are suitable for use with the present disclosure. In certain embodiments, the one or more base chemicals can include at least one strong base, and each of the one or more base chemicals in the processing solution can be strong bases. In certain embodiments, the one or more base chemicals can include at least one weak base, and each of the one or more base chemicals in the processing solution can be weak bases. In certain embodiments, the one or more base chemicals can include at least one weak base and at least one strong base in the processing solution.

In certain embodiments, the processing solution can include multiple base chemicals. The multiple base chemicals can be different from each other. For example, in certain embodiments, the processing solution can include a hydroxide compound and an amine compound. The hydroxide compound can be sodium hydroxide and the amine compound can be monoethylamine (MEA). A person skilled in the art will appreciate a wide combination of base chemicals are suitable for use with the present disclosure.

Methods of the present disclosure provide multiple analytical methods and measurements of the processing solution, for example, in order to advantageously selectively measure multiple base chemicals in a same processing solution. In certain embodiments, the conductivity, titration, and pH measurements of the processing solution can be determined. These measurements can advantageously be used to selectively determine the concentration of multiple base chemicals in the processing solution. In certain embodiments, a first analytical method, such as titration measurements, can be combined with a second analytical method, such as conductivity measurements. Further, in certain embodiments, a first analytical method, such as pH measurements, can be combined with a second analytical method, such as conductivity measurements.

In certain embodiments, the conductivity of the processing solution can be measured. For example, in certain embodiments, the conductivity of the processing solution can be measured by a conductivity meter. Each base species in the processing solution can contribute to the measured conductivity as follows: Conductivity=a×(Concentration of Base 1, N)+b×(Concentration of Base 2, N). Coefficients (a) and (b) can determined by conductivity measurement of several standard solutions with known concentration of the base. In certain embodiments, the conductivity measurement can be performed at a fixed temperature or temperature compensation. In certain embodiments, the conductivity measurement can be performed at room temperature, for example, at about 22° C.

In certain embodiments, the one or more base chemicals can be titrated together as a total base. For example, in certain embodiments, a total base titration can be performed by adding a titrant/acid with a known concentration to a fixed volume of an unknown base sample until an end point is reached. The end point can be determined, for example, by a pH indicator a or pH electrode and the titrant volume can be recorded. The total base (N) can be determined as follows. Total base (N)=Concentration of the titrant/acid×Volume of the titrant/Volume of the unknown base sample. In certain aspects, each base species in the processing solution can contribute to the measured total base by titration (N) as follows: Total base by Titration, N=(Concentration of Base 1, N)+(Concentration of Base 2, N).

In certain embodiments, the pH of the processing solution can be measured. For example, in certain embodiments, the pH can be measured by a pH electrode. Each base species in the processing solution can contribute to the measured pH of the processing solution as follows: pH=f1 (Concentration of Base 1, N)+f1×(Concentration of Base 2, N), where f1 and f2 can be linear or log function. For example, f(x)=n+mX, or f(x)=N+M log(x).

In certain aspects, the one or more base chemicals can be measured by the conductivity and titration measurements of the processing solution. For example, in certain embodiments, the concentration of the one or more base chemicals can be determined as follows: Concentration (Base (i))=offset+Conductivity×Conductivity Slope (j)+Total_Base×Total_Base Slope (j).

In certain aspects, the one or more base chemicals can be measured by the conductivity and pH measurements of the processing solution. For example, the concentration of the one or more base chemicals can be determined as follows: Concentration (Base (i))=offset+Conductivity×Conductivity Slope (j)+pH×pH Slope (j).

Methods of the present disclosure provide for determining a concentration of at least one base chemical in a processing solution. The processing solution can include a plurality of base chemicals. In certain embodiments, the method can include providing the processing solution. The processing solution can include a plurality of base chemicals, for example, a first base chemical and a second base chemical. In certain embodiments, a first analytical method of the processing solution can be performed to provide a first measurement. The first analytical method can include measuring the conductivity of the processing solution. In certain embodiments, the method can include performing a second analytical method of the processing solution to provide a second measurement. The second analytical method can include measuring the pH of or titrating the processing solution. The method can further include determining a concentration of at least one of the first and second base chemicals based on the first and second measurements. In certain embodiments, the first base chemical is different than the second base chemical. In certain embodiments, the first analytical method is different than the second analytical method.

Methods of the present disclosure further provide for determining a concentration of at least one base chemical in a processing solution. In certain embodiments, the method can include providing the processing solution. The processing solution can include a hydroxide compound and an amine compound. A first analytical method of the processing solution can be performed to provide a first measurement. The first analytical method can include measuring the conductivity of the processing solution. In certain embodiments, the method can include performing a second analytical method of the processing solution to provide a second measurement. The second analytical method can include measuring the pH of or titrating the processing solution. The method can further include determining a concentration of at least one of the hydroxide compounds and the amine compound based on the first and second measurements. In certain embodiments, the first analytical method is different than the second analytical method.

The presently disclosed subject matter will be better understood by reference to the following Examples. The following Examples are merely illustrative of the presently disclosed subject matter and should not be considered as limiting the scope of the subject matter in any way.

### EXAMPLES

The following Examples are merely illustrative of the presently disclosed subject matter and they should not be considered as limiting the scope of the subject matter in any way.

### Example 1: Selective Measurement of Sodium Hydroxide (NaOH) and Monoethylamine (MEA) in a Solution Blend

This Example provides for selective measurement of two different base chemicals, sodium hydroxide (NaOH) and monoethylamine (MEA), in a solution blend. Both bases were strong (at least in DIW-based matrix) and titrated together as a total base. Nine (9) samples (Samples 1-9) were prepared as provided in Table 1. Measurements of the samples were used in various calculations noted below to selectively determine the concentration of multiple bases in the solution blend. The total base (N) was measured by titrating 10 mL of the sample with 0.1N hydrogen chloride (HCl). The end point was determined by a pH electrode and the end volume of the titrant (0.1N HCl) was recorded. The total base (N) was calculated as titrant concentration (0.1N)*end volume/sample volume (10 mL). The pH of the sample was measured by a pH electrode. The conductivity (mS/cm) of the sample was measured by a conductivity meter. The results are provided in Table 1.

The calculations below are an expression of how each base species can contribute to the measured signals (i.e., titration, conductivity and pH).
Total base by Titration, N=(Concentration of Base 1 (NaOH), N)+(Concentration of Base 2 (MEA), N).
Conductivity=a×(Concentration of Base 1 (NaOH), N)+b×(Concentration of Base 2 (MEA), N). Coefficients (a) and (b) were determined by conductivity measurements of several standard solutions with a known concentration of the base.
pH=f1 (Concentration of Base 1 (NaOH), N)+f1×(Concentration of Base 2 (MEA), N), where f1 and f2 can be linear or log function. For example, f(x)=n+mX, or f(x)=N+M log(x).

TABLE 1

| | | | | | | Total Base |
|---|---|---|---|---|---|---|
| Sam- | NaOH | MEA | Conductivity | Temperature | | (N) from |
| ple | (N) | (N) | (uS/cm) | (° C.) | pH | Titration |
| 1 | 0.01 | 0 | 2088 | 25.9 | 12.02 | 0.0093 |
| 2 | 0.01 | 0.005 | 2075 | 26.1 | 12.004 | 0.0142 |
| 3 | 0.01 | 0.01 | 2123 | 25.7 | 12.003 | 0.0189 |
| 4 | 0.01 | 0.05 | 2133 | 25.7 | 12.007 | 0.0594 |
| 5 | 0 | 0.01 | 116.4 | 24.2 | 10.733 | 0.0096 |
| 6 | 0.0025 | 0.01 | 554.9 | 24.5 | 11.356 | 0.0119 |
| 7 | 0.005 | 0.01 | 1088 | 24.2 | 11.631 | 0.0142 |
| 8 | 0.0075 | 0.01 | 1616 | 24.4 | 11.811 | 0.0169 |
| 9 | 0 | 0.05 | 264.8 | 24.8 | 11.075 | 0.0501 |

From the titration and conductivity measurements provided in Table 1, the concentration of NaOH and MEA in solution was selectively determined.

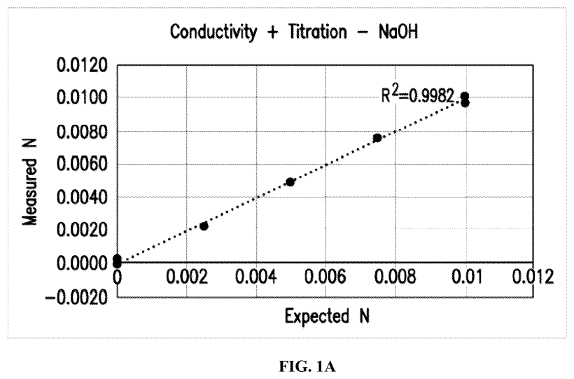

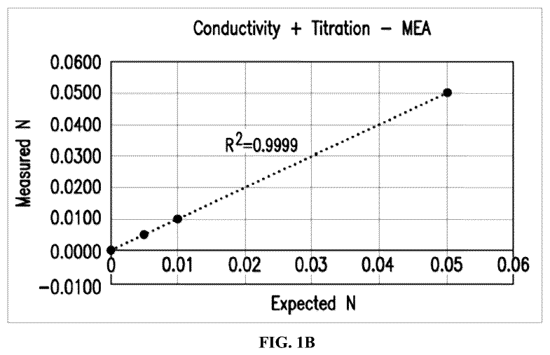

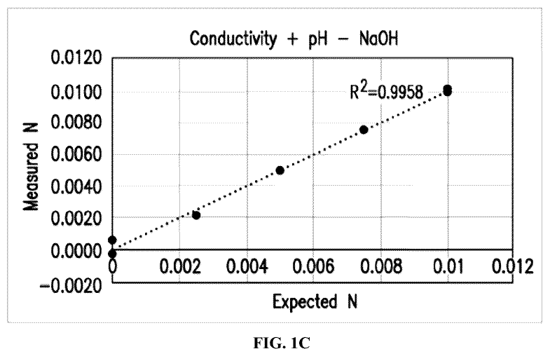

The results with respect to NaOH are provided in Table 2 and FIG. 1A.

TABLE 2

| | | Titration + | |
|---|---|---|---|
| | NaOH | Conductivity | |
| Sample | (N) | Measured | Accuracy |
| 1 | 0.01 | 0.0101 | 0.0001 |
| 2 | 0.01 | 0.0100 | 0.0000 |
| 3 | 0.01 | 0.0102 | 0.0002 |
| 4 | 0.01 | 0.0098 | −0.0002 |
| 5 | 0 | 0.0000 | 0.0000 |
| 6 | 0.0025 | 0.0022 | −0.0003 |
| 7 | 0.005 | 0.0049 | −0.0001 |
| 8 | 0.0075 | 0.0076 | 0.0001 |
| 9 | 0 | 0.0003 | 0.0003 |
| Average | | | 0.0001 |
| Accuracy | | | |

The results with respect to MEA are provided in Table 3 and FIG. 1B.

TABLE 3

| | | Titration + | |
|---|---|---|---|
| | | Conductivity | |
| Sample | MEA (N) | Measured | Accuracy |
| 1 | 0 | 0.0001 | 0.0001 |
| 2 | 0.005 | 0.0051 | 0.0001 |
| 3 | 0.01 | 0.0096 | −0.0004 |
| 4 | 0.05 | 0.0501 | 0.0001 |
| 5 | 0.01 | 0.0100 | 0.0000 |
| 6 | 0.01 | 0.0102 | 0.0002 |
| 7 | 0.01 | 0.0099 | −0.0001 |
| 8 | 0.01 | 0.0101 | 0.0001 |
| 9 | 0.05 | 0.0498 | −0.0002 |
| Average | | | 0.0002 |
| Accuracy | | | |

From the pH and conductivity measurements provided in Table 1, the concentration of NaOH in solution was selectively determined. The results are provided in Table 4 and FIG. 1C.

TABLE 4

| | | pH + | |
|---|---|---|---|
| | NaOH | Conductivity | |
| Sample | (N) | Measured | Accuracy |
| 1 | 0.01 | 0.0099 | −0.0001 |
| 2 | 0.01 | 0.0099 | −0.0001 |
| 3 | 0.01 | 0.0101 | 0.0001 |
| 4 | 0.01 | 0.0102 | 0.0002 |
| 5 | 0 | −0.0003 | −0.0003 |
| 6 | 0.0025 | 0.0022 | −0.0003 |
| 7 | 0.005 | 0.0049 | −0.0001 |
| 8 | 0.0075 | 0.0075 | 0.0000 |
| 9 | 0 | 0.0006 | 0.0006 |
| Average | | | 0.0002 |
| Accuracy | | | |

As shown in Tables 2-4 and FIGS. 1A-C, methods of the present disclosure provide for accurate and selective measuring and monitoring of multiple base chemicals in a solution blend.

Calculation Parameters

The following calculation parameters (Equations 1-2 and Tables 4-5) were used to selectively determine the measured concentration of the multiple base chemicals in the solution blend.

Concentration(Base(i))=offset+Conductivity×Conductivity Slope(j)+Total_Base×Total_Base Slope(j) Equation 1:

TABLE 5

Conductivity + Titration
Coefficients

| | NaOH | MEA |
|---|---|---|
| Conductivity Slope | 0.000005131 | −0.000004863 |
| Total Base Slope | −0.0116434 | 1.0015 |
| Offset | −0.000499 | 0.000975 |

Concentration(NaOH)=offset+Conductivity×Conductivity Slope+pH×pH Slope Equation 2:

TABLE 6

| | Conductivity + pH |
|---|---|
| | Coefficients |
| | NaOH |
| Conductivity Slope | 0.00000489 |
| pH Slope | 0.0004239 |
| Offset | −0.005369 |

### Example 2: Selective Measurement of Multiple Bases (Base 1 and Base 2) in a Solution Blend

This Example provides for selective measurement of two different base chemicals, Base 1 (B) and Base 2 (TMAH), in a commercial formulation for cleaning of semiconductor devices. Both bases were titrated together as a total base. Nine (9) samples (Samples 10-18) were prepared as provided in Table 7. Measurements of the samples were used in various calculations noted below to selectively determine the concentration of multiple bases in the solution blend. The total base (N) was measured by titrating 1 mL of the sample with 0.1N hydrogen chloride (HCl). The end point was determined by a pH electrode and the end volume of the titrant (0.1N HCl) was recorded. The total base (N) was calculated as titrant concentration (0.1N)*end volume/sample volume (1 mL). The pH of the sample was measured by a pH electrode. The conductivity (mS/cm) of the sample was measured by a conductivity meter. The results are provided in Table 7.

The calculations below are an expression of how each base species can contribute to the measured signals (i.e., titration, conductivity and pH).
Total base by Titration, N=(Concentration of Base 1 (B), N)+(Concentration of Base 2 (TMAH), N).
Conductivity=a×(Concentration of Base 1 (B), N)+b×(Concentration of Base 2 (TMAH), N). Coefficients (a) and (b) were determined by conductivity measurements of several standard solutions with a known concentration of the base.
pH=f1 (Concentration of Base 1 (B), N)+f1×(Concentration of Base 2 (TMAH), N), where f1 and f2 can be linear or log function. For example, f(x)=n+mX, or f(x)=N+M log(x).

TABLE 7

| | Expected | Expected | | | |
|---|---|---|---|---|---|
| | Base 1 | Base 2 | Conductivity | Total Base (N) | |
| Sample | wt % | wt % | (mS/cm) | by Titration | pH |
| 10 | 0.62 | 0.67 | 10.84 | 0.1236 | 7.769 |
| 11 | 0.80 | 0.71 | 13.22 | 0.1478 | 7.589 |
| 12 | 0.58 | 0.76 | 10.8 | 0.1315 | 7.912 |
| 13 | 0.67 | 0.80 | 11.61 | 0.1384 | 8.023 |
| 14 | 0.49 | 0.58 | 9.3 | 0.1047 | 7.59 |
| 15 | 0.53 | 0.49 | 9.405 | 0.09876 | 7.468 |
| 16 | 0.76 | 0.53 | 11.84 | 0.1235 | 7.347 |
| 17 | 0.71 | 0.62 | 11.71 | 0.1267 | 7.711 |
| 18 | 0.30 | 0.40 | 6.596 | 0.07083 | 7.271 |

From the titration and conductivity measurements provided in Table 7, the concentration of Base 1 (B) and Base 2 (TMAH) in solution was selectively determined.

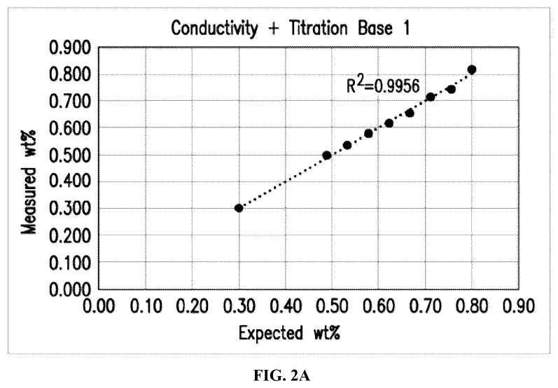

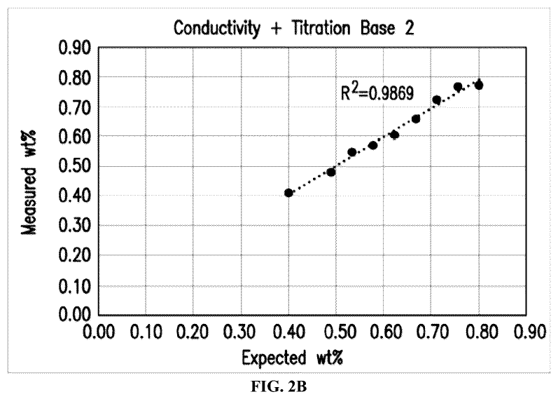

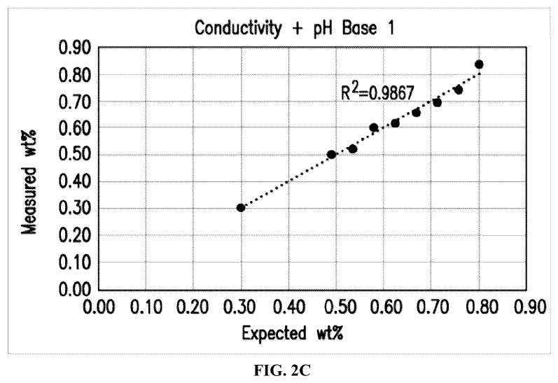

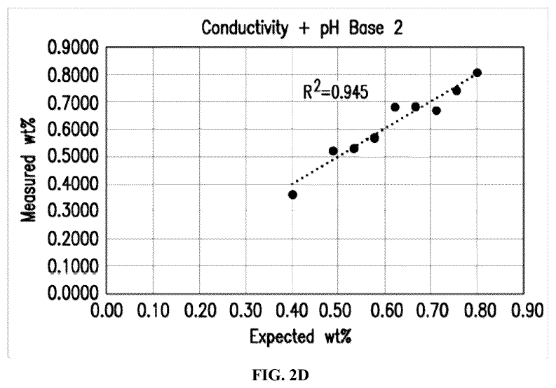

The results with respect to Base 1 (B) are provided in Table 8 and FIG. 2A.

TABLE 8

| | | Conductivity + | |
|---|---|---|---|
| | Expected Base 1 | Titration | |
| Sample | wt % | Measured (Base 1) | Accuracy |
| 10 | 0.622 | 0.616 | −0.006 |
| 11 | 0.800 | 0.817 | 0.017 |
| 12 | 0.578 | 0.578 | 0.000 |
| 13 | 0.667 | 0.652 | −0.015 |
| 14 | 0.489 | 0.499 | 0.011 |
| 15 | 0.533 | 0.538 | 0.004 |
| 16 | 0.756 | 0.744 | −0.012 |
| 17 | 0.711 | 0.714 | 0.003 |
| 18 | 0.300 | 0.298 | −0.002 |

The results with respect to Base 2 (TMAH) are provided in Table 9 and FIG. 2B.

TABLE 9

| | | Conductivity + | |
|---|---|---|---|
| | Expected Base 2 | Titration | |
| Sample | wt % | Measured (Base 2) | Accuracy |
| 10 | 0.667 | 0.656 | −0.010 |
| 11 | 0.711 | 0.722 | 0.011 |
| 12 | 0.756 | 0.766 | 0.011 |
| 13 | 0.800 | 0.771 | −0.029 |
| 14 | 0.578 | 0.570 | −0.007 |
| 15 | 0.489 | 0.480 | −0.009 |
| 16 | 0.533 | 0.547 | 0.013 |
| 17 | 0.622 | 0.604 | −0.019 |
| 18 | 0.400 | 0.410 | 0.010 |

From the pH and conductivity measurements provided in Table 7, the concentration of Base 1 (B) and Base 2 (TMAH) in solution was selectively determined.

The results with respect to Base 1 (B) are provided in Table 10 and FIG. 2C.

TABLE 10

| | Expected Base 1 | Conductivity + pH | |
|---|---|---|---|
| Sample | wt % | Measured (Base 1) | Accuracy |
| 10 | 0.622 | 0.614 | −0.008 |
| 11 | 0.800 | 0.834 | 0.034 |
| 12 | 0.578 | 0.596 | 0.019 |
| 13 | 0.667 | 0.654 | −0.012 |
| 14 | 0.489 | 0.500 | 0.012 |
| 15 | 0.533 | 0.521 | −0.012 |
| 16 | 0.756 | 0.740 | −0.015 |
| 17 | 0.711 | 0.693 | −0.018 |
| 18 | 0.300 | 0.302 | 0.002 |

The results with respect to Base 2 (TMAH) are provided in Table 11 and FIG. 2D.

TABLE 11

| | Expected Base 2 | Conductivity + pH | |
|---|---|---|---|
| Sample | wt % | Measured (Base 2) | Accuracy |
| 10 | 0.667 | 0.681 | 0.014 |
| 11 | 0.711 | 0.667 | −0.045 |
| 12 | 0.756 | 0.740 | −0.016 |
| 13 | 0.800 | 0.807 | 0.007 |
| 14 | 0.578 | 0.567 | −0.010 |
| 15 | 0.489 | 0.519 | 0.030 |
| 16 | 0.533 | 0.531 | −0.003 |
| 17 | 0.622 | 0.679 | 0.057 |
| 18 | 0.400 | 0.366 | −0.034 |

As shown in Tables 8-11 and FIGS. 2A-D, methods of the present disclosure provide for accurate and selective measuring and monitoring of multiple base chemicals in a solution blend.

Calculation Parameters

The following calculation parameters (Equations 3-4 and Tables 12-13) were used to selectively determine the measured concentration of the multiple base chemicals in the solution blend.

Concentration(Base(i))=offset+Conductivity×Conductivity Slope(j)+Total_Base×Total_Base Slope(j) Equation 3:

TABLE 12

Conductivity + Titration
Coefficients

| | Base 1 (B) | Base 2 (TMAH) |
|---|---|---|
| Conductivity Slope | 0.1272245 | −0.1083299 |
| Total Base Slope | −4.198479 | 13.3717849 |
| Offset | −0.24411 | 0.177888 |

Concentration(Base(i))=offset+Conductivity×Conductivity Slope(j)+pH×pH Slope(j) Equation 4:

TABLE 13

Conductivity + pH Coefficients

| | Base 1 (B) | Base 2 (TMAH) |
|---|---|---|
| Conductivity Slope | 0.085022 | 0.025397 |
| pH Slope | −0.09782 | 0.416798 |
| Offset | 0.45216 | −2.83233 |

### * * *

The description herein merely illustrates the principles of the disclosed subject matter. Various modifications and alterations to the described embodiments will be apparent to those skilled in the art in view of the teachings herein. Accordingly, the disclosure herein is intended to be illustrative, but not limiting, of the scope of the disclosed subject matter. Moreover, the principles of the disclosed subject matter can be implemented in various configurations and are not intended to be limited in any way to the specific embodiments presented herein.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A method for determining a concentration of at least one base chemical in a processing solution including a first base chemical and a second base chemical, comprising:
performing a first analytical method comprising measuring a conductivity of the processing solution to provide a first measurement;
performing a second analytical method of the processing solution to provide a second measurement; and
determining a concentration of at least one of the first base chemical and the second base chemical based on the first and second measurements,
wherein the first base chemical is different than the second base chemical, and wherein the first analytical method is different than the second analytical method.

2. The method of claim 1, wherein the second analytical method comprises titrating the processing solution.

3. The method of claim 1, wherein the second analytical method comprises measuring the pH of the processing solution.

4. The method of claim 1, wherein the first base chemical and the second base chemical are strong bases.

5. The method of claim 1, wherein the processing solution is a semiconductor processing solution.

6. The method of claim 1, wherein the first base chemical comprises a hydroxide compound.

7. The method of claim 6, wherein the first base chemical is sodium hydroxide (NaOH), potassium hydroxide (KOH), or lithium hydroxide (LiOH).

8. The method of claim 1, wherein the second base chemical comprises an amine compound.

9. The method of claim 8, wherein the second base chemical is monoethylamine (MEA), ammonium hydroxide, tetramethylammonium hydroxide (TMAH), tetraethyl ammonium hydroxide (TEAH), tetrapropylammonium hydroxide, trimethylhydroxyethylammonium hydroxide, dimethyldihydroxyethylammonium hydroxide, methyltrihydroxyethylammonium hydroxide, phenyltrimethylammonium hydroxide, phenyltriethylammonium hydroxide, or benzyltrimethylammonium hydroxide.

10. The method of claim 1, wherein the conductivity of the processing solution is measured at a fixed temperature.

11. A method for determining a concentration of at least one base chemical in a processing solution including a hydroxide compound and an amine compound, comprising:
performing a first analytical method comprising measuring a conductivity of the processing solution to provide a first measurement;
performing a second analytical method of the processing solution to provide a second measurement; and
determining a concentration of at least one of the hydroxide compound and the amine compound based on the first and second measurements,
wherein the first analytical method is different than the second analytical method.

12. The method of claim 11, wherein the second analytical method comprises titrating the processing solution.

13. The method of claim 11, wherein the second analytical method comprises measuring the pH of the processing solution.

14. The method of claim 11, wherein the hydroxide compound and the amine compound are strong bases.

15. The method of claim 11, wherein the processing solution is a semiconductor processing solution.

16. The method of claim 11, wherein the hydroxide compound is sodium hydroxide (NaOH), potassium hydroxide (KOH), or lithium hydroxide (LiOH).

17. The method of claim 11, wherein the amine compound is monoethylamine (MEA), ammonium hydroxide, tetramethylammonium hydroxide (TMAH) tetraethyl ammonium hydroxide (TEAH), tetrapropylammonium hydroxide, trimethylhydroxyethylammonium hydroxide, dimethyldihydroxyethylammonium hydroxide, methyltrihydroxyethylammonium hydroxide, phenyltrimethylammonium hydroxide, phenyltriethylammonium hydroxide, or benzyltrimethylammonium hydroxide.

18. The method of claim 11, wherein the conductivity of the processing solution is measured at a fixed temperature.
